(19) United States
(12) Patent Application Publication
(10) Pub. No.: US 2025/0181924 A1
(43) Pub. Date: Jun. 5, 2025

(54) TRAINING NEURAL NETWORKS BY CAPTURING HIGHER-LEVEL TRAINING CONTRIBUTIONS

(71) Applicant: Robert Bosch GmbH, Stuttgart (DE)

(72) Inventors: Eduardo Monari, Karlsruhe (DE); Sabine Haag, Denkendorf (DE); Sabrina Schmedding, Tiefenbronn (DE); Tobias Schlagenhauf, Albstadt (DE)

(21) Appl. No.: 18/952,129

(22) Filed: Nov. 19, 2024

(30) Foreign Application Priority Data
Nov. 30, 2023 (DE) 10 2023 211 986.2

(51) Int. Cl. G06N 3/09; G06F 18/2135

(52) U.S. Cl. CPC G06N 3/09; G06F 18/2135

(57) ABSTRACT

A method for training a neural network that has a feature extractor for converting measurement data into a representation in a feature space and a task head for ascertaining an output in relation to a predefined task from the representation. In the method, one or more samples of measurement data are processed (by the neural network to produce outputs; from these outputs, it is evaluated according to a predefined criterion whether the particular sample belongs to the domain and/or distribution of the previously used training examples; and if this is not the case: target outputs are obtained for one or more samples and these samples are labeled with these target outputs, the neural network is further trained with the newly labeled sample(s) in a monitored manner.

### FIELD

The present invention relates to the training of neural networks that are used, for example, for the evaluation of measurement data in quality control or the monitoring of industrial plants.

### BACKGROUND INFORMATION

Measurement data that are generated during the quality control of finished products or during the monitoring of machines or industrial plants are often evaluated using neural networks. These networks have great power to generalize. If they have been confronted with a variety of situations during training, they can also make statements about situations not seen during training.

This capability is limited to situations that still substantially belong to the same domain or distribution as the training examples used in training. If measurement data from an entire fleet of machines or industrial plants are to be evaluated, there are often shifts between the domains or distributions of the measurement data, even between similar machines or plants, in particular if the machines or industrial plants are operated in different ways or for different purposes. A single neural network in a specific trained state does not then fully match the measurement data generated in all machines or industrial plants. In order not to multiply the training effort completely with the number of machines or industrial plants, the neural network can, for example, be pre-trained generically and then be fully trained specifically for each individual machine or industrial plant (fine-tuning).

### SUMMARY

The present invention provides a method for training a neural network. This neural network has a feature extractor for converting measurement data into a representation in a feature space and a task head for ascertaining an output in relation to a predefined task from the representation. Thus, it processes the measurement data in two steps.

According to an example embodiment of the present invention, the method starts from a state in which the neural network has either not yet been trained at all or has already been trained with a specific set of training examples. If the neural network has not yet been trained, the parameters that characterize its behavior may, for example, have been randomly initialized. If the neural network has already been trained, its parameters may have been trained, for example within the framework of monitored training, to process the training examples as best as possible into target outputs with which the training examples are labeled.

Within the framework of the method, one or more samples of measurement data are processed by the neural network to produce outputs. From these outputs, it is evaluated whether the particular sample belongs to the domain and/or distribution of the previously used training examples. If the neural network has just been initialized, the set of previously used training examples is still empty.

The extent to which it is clear from the output of the neural network whether the sample processed to produce this output belongs to the domain and/or distribution of the previously used training examples depends on the specific application. This can be determined particularly easily, for example, if the task head is designed to process the representation into classification scores in relation to one or more classes of a predefined classification. Then, for example, the level of these classification scores provides information about how confident the neural network is in assigning it to one or more classes. For example, a “one-hot” classification score that is 1 for only one class and 0 for all other classes may indicate that the sample belongs to the domain and/or distribution of training examples and can be reliably assigned to exactly one class. On the other hand, a distribution of classification scores that is smeared across all classes with only a weakly pronounced maximum, or no maximum at all, indicates that the sample does not belong to the domain and/or distribution of training examples and that the neural network is less likely to be able to do anything with it.

In the latter case, action is needed to supplement the training of the neural network so that it can better process such samples in the future. Therefore, target outputs are obtained for samples that do not belong to the domain and/or distribution of the previously used training examples, and these samples are labeled with these target outputs. Here, the target outputs can come from any source. For example, a domain expert can examine the measurement data and/or further investigations can be carried out on an object where the measurement data were recorded. For example, in the quality control of workpieces, obtaining target outputs can comprise sawing the workpiece and metallurgically investigating its interior.

Alternatively or in combination with classification scores, the task head can also ascertain regression values of any desired variables, for example. For example, if the measurement data relate to a machine and/or industrial plant, the variable sought can indicate a process parameter or a quality indicator (key performance indicator, KPI), for example.

Optionally, a further distinction can be made between samples that are clearly outside the domain and/or distribution of the previously used training examples, and samples for which it is borderline whether or not they belong to this domain and/or distribution. This distinction can, for example, be reflected in the priority with which target outputs are obtained for the samples. The allocation of such priorities can be particularly useful if obtaining target tasks is complex and expensive, as in the case of the aforementioned metallurgical investigation.

The neural network is further trained with the newly labeled sample(s) in a monitored manner. In particular, this can include, for example, optimizing the parameters that characterize the behavior of the neural network such that the newly labeled samples in each case are now also processed into the corresponding target outputs. This creates a new training level of the neural network. During further training, in particular a working copy of the neural network can be created, for example, so that the network remains consistent and its parameters are not changed simultaneously, for example, by training and by a higher-level update of the feature extractor.

Using a test data set labeled with target outputs, it is now checked whether the performance of the further trained neural network has improved with regard to the predefined task compared to the state prior to further training. The test data set contains test examples that were not used during training and that the neural network thus cannot have “learned by heart” during training without really internalizing the knowledge contained therein (overfitting).

If the performance of the trained neural network has improved, extractor parameters that characterize the behavior of the feature extractor and/or changes to these parameters are made available as a training contribution for a distributed training of the feature extractor.

It has been recognized that when training a fleet of neural networks, in particular for not completely identical but at least similar applications, the progress achieved in the area of feature extraction can be generalized across the fleet. It is therefore advantageous if this progress also benefits other members of the fleet. Progress in training the particular task head, on the other hand, is more specific to the concrete application and cannot be used for other applications or can only be used to a limited extent.

It has also been recognized that by checking for progress using the test data set, different speeds at which progress can be made in the particular applications can also be taken into account. In a fleet of neural networks, which are all fed with measurement data from different sources, some networks can make progress very quickly, while other networks need to collect newly labeled samples for longer before making progress.

One possible reason for this is the different levels of difficulty of the particular tasks. For example, if multiple neural networks are used for optical quality control of different workpieces, anomalies on specific types of workpieces may be physically recognizable with better contrast than on other types of workpieces.

Furthermore, the availability of samples with specific properties can also influence the speed of training progress. For example, if the neural network is to learn to recognize specific anomalies, a certain number of samples with precisely these anomalies is required. However, with industrial manufacturing, anomalies are rare events-if this were not the case, the manufacturing process as a whole would not be usable. Therefore, it may take more or less time until a sufficient number of samples with the particular anomaly have been collected. However, once corresponding samples have been collected, they can also benefit other structurally identical or similar machines or industrial plants in the fleet by sharing training contributions for the feature extractor. The generalized feature extractor can then be used for anomaly recognition without a task head as such, for example by improving the performance of anomaly recognition on the basis of an autoencoder or statistical outlier recognition in the latent space of representations.

Also, the availability of computing time for training the neural networks can also vary. For example, the hardware platforms in each case used for training can be equipped to varying degrees. For example, the energy costs for training at different locations can vary differently depending on the time of day.

If a specific neural network in the fleet has particularly great difficulty with the newly labeled samples, its performance may initially deteriorate before improving again. In simple terms, a valley of tears must be crossed in order to later gain the ability to process the new samples. However, this is solely a matter of this neural network, or of a node on which this neural network is executed. By only forwarding extractor parameters for the distributed training of the feature extractor if the particular neural network has made progress, a possible “valley of tears” is kept away from the rest of the fleet.

Compared to central training, for which all samples are collected from all applications, distributed training has the advantage of eliminating the effort required to transfer the samples to a central entity that carries out the training. Depending on the type of samples, this can require a significant amount of network bandwidth. At the same time, measurement data collected in machines and industrial plants are confidential data. From these data, for example, the type and quantity of products manufactured, or even manufacturing processes, can be reconstructed. This poses particularly major problems for a central data collection that spans neural networks located in different companies. In applications in which personal data are processed, such as images of recognizable people or license plates, central collection across geopolitical borders may also fail due to legal regulations on data protection.

The distributed training of the feature extractor can, for example, be swarm training, which is also called “decentralized training.” Here, different nodes at which neural networks are trained exchange the extractor parameters and/or changes to these extractor parameters directly with one another without a central orchestrating entity.

In a particularly advantageous example embodiment of the present invention, the samples of measurement data are processed on a client node C1, . . . , CN for federated training of the feature extractor to produce outputs. Here, the feature extractor is used in a state that is characterized by extractor parameters received from a server node Q. The ascertained training contribution is then transmitted back to a server node Q. The server node Q then aggregates the training contributions received from all client nodes C1, . . . , CN into, in each case, a new version of the extractor parameters, which can subsequently be deployed to all client nodes C1, . . . , CN. In particular, the server node Q can determine when it is time to transmit a new version of the aggregated extractor parameters to the client nodes C1, . . . , CN. The client nodes C1, . . . , CN can then adopt the new extractor parameters either immediately or after completing an ongoing training session, for example.

According to an example embodiment of the present invention, it is particularly advantageous to use a separate labeled test data set on each client node C1, . . . , CN to check whether the performance of the neural network that has been further trained has improved. In this way, the check can be adapted for the particular application of this client node C1, . . . , CN. For example, in each application there may be a specific canon of test examples that the neural network must master.

In a further particularly advantageous example embodiment of the present invention
a software implementation of the neural network on at least one client node C1, . . . , CN, and/or
a hardware platform of this client node C1, . . . , CN, on which the neural network is executed,
is adapted to the measurement data specifically generated at this client node C1, . . . , CN. In this way, the samples of measurement data that are generated in each case in each application can be processed in a particularly efficient manner, so that a considerable amount of computing time and/or energy can be saved across the entire fleet. If, for example, the particular neural network in an application can also be operated sensibly with fixed-point or integer arithmetic, a hardware platform specialized for this purpose can be used, which then works significantly more energy-efficiently and faster than universal (“general purpose”) hardware platforms, such as CPUs or GPUs.

In a further particularly advantageous example embodiment of the present invention, the further training of at least one client node C1, . . . , CN is carried out according to a time program, which is specified using the time dependency of the energy costs and/or environmental impacts of this training at the location of the client node C1, . . . , CN. This results in energy cost savings and reduced environmental impact across the entire fleet. For example, electricity prices are strongly dependent on the time of day and, in particular, on the supply of electricity from solar and wind power. If active cooling of the client node C1, . . . , CN is needed, the energy required for this can also be taken into account in the time program. For example, at night, when outside temperatures are at their lowest, active cooling can be turned down or switched off completely, because passive cooling is sufficient. On the whole, this may be more cost-effective than obtaining the cheapest electricity around midday, only to use more of it for cooling. In general, smaller hardware platforms, such as edge devices in industrial plants, can be operated and cooled with lower energy consumption than large data centers, such as those required to process all samples from the fleet at once.

In a further particularly advantageous example embodiment of the present invention, samples to be newly labeled and/or newly labeled samples are collected in a batch. Further training is then carried out on such a batch. This can be used in particular to ensure, for example, that further training is only attempted if the collected samples allow for the recognition of the desired correlation. If the neural network were always served the newly labeled samples individually, further training would always be based solely on the information from each individual sample. Correlations between samples, and thus a significant portion of the measurement data, would remain unconsidered.

As an indicator that the performance of the neural network has improved, in particular the mean value of a deviation of the outputs generated from the newly labeled samples from the particular target outputs can be used, for example. Alternatively, or in combination with this, the mean value of a cost function that evaluates at least this deviation can be used. If the particular indicator falls below a predefined threshold, it can then be determined that the performance of the further trained neural network has improved. In particular, the cost function can also measure, for example, whether the performance of the neural network is still present on the previously used training examples or whether “catastrophic forgetting” has occurred. However, performance can also be measured, for example, using any measure of accuracy in the context of the predefined task.

In a further particularly advantageous example embodiment of the present invention, in a first phase of further training, the extractor parameters are retained and only the task head parameters that characterize the behavior of the task head are optimized. Only in a second phase of further training are the extractor parameters optimized together with the task head parameters. In this way, it can be avoided that the neural network hastily makes suggestions for changes to the extractor parameters, which also affect the rest of the fleet, when it would actually be more appropriate to change only the locally affecting parameters of the task head. The transition from the first phase to the second phase can be controlled using any criterion. For example, the transition can be initiated in response to the task head parameters and/or the performance of the neural network no longer changing significantly.

The measurement data can in particular comprise, for example, tabular data, time series, images and/or point clouds. For example, in each case an image can assign values of at least one measurement quantity to pixels in a regular grid. A point cloud can assign values of at least one measurement quantity to points in three-dimensional space, which do not have to be regularly arranged or connected.

In a further particularly advantageous example embodiment of the present invention, a neural network is selected that is designed for controlling and/or monitoring a machine and/or an industrial plant. The obtaining of target outputs comprises requesting these target outputs from an operator of the machine and/or industrial plant. The distributed training of the feature extractor extends to other identical or similar machines and/or industrial plants.

In this way, knowledge that is available to the operator of the machine and/or industrial plant and may only be available there as unwritten experiential knowledge can be transferred into the neural network and thus into a form that can be used by machines.

As explained above, this advantage, in addition to the already mentioned advantages of distributed training, is particularly evident in machines and/or industrial plants. Machines and/or industrial plants in particular are often used in large numbers in identical or similar form, but with different configurations and/or for different purposes. Thus, fleets are created in which, by means of the proposed method, both the outlay for training is reduced, and, due to the collaboration of many machines and/or industrial plants, an overall better training outcome can be achieved.

The ultimate goal of training is to use the trained neural network to provide a better tool for evaluating measurement data in the predefined application. Therefore, in a further particularly advantageous embodiment, measurement data are fed to the fully trained neural network. A control signal is ascertained from the output generated by the trained neural network. A vehicle, a driver assistance system, a robot, a system for quality control, a machine and/or an industrial plant is controlled with the control signal. In this way, the probability is increased that the reaction of the system being controlled in each case in response to the control signal is appropriate to the reaction embodied by the measurement data.

The method of the present invention can in particular be wholly or partially computer-implemented. The present invention therefore also relates to a computer program comprising machine-readable instructions that, when executed on one or more computers and/or compute instances, cause the computer(s) and/or compute instances to execute the disclosed method of the present invention. In this sense, control devices for vehicles and embedded systems for technical devices, which are also capable of executing machine-readable instructions, are also to be regarded as computers. Compute instances can be virtual machines, containers or serverless execution environments, for example, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIGS. 1A and 1B show an exemplary embodiment of the method 100 for training a neural network 1, according to the present invention.

FIG. 2 shows exemplary training of only the task head according to block 143 with first obtained target outputs 6a, according to the present invention.

FIG. 3 shows exemplary semi-monitored training of the complete neural network 1 according to block 144 with forwarding of training contributions 2a for the feature extractor 2.

### DETAILED DESCRIPTION OF EXAMPLE EMBODIMENTS

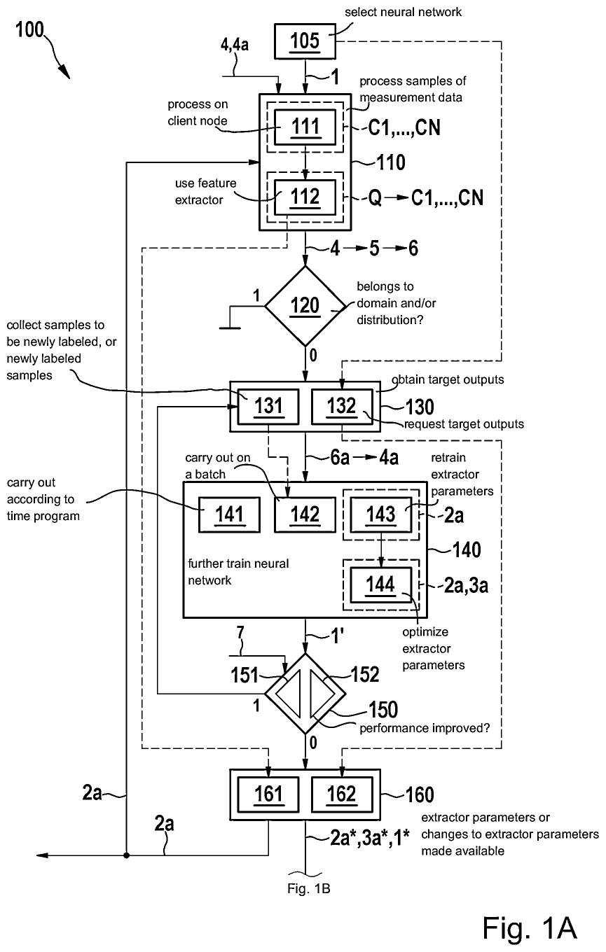

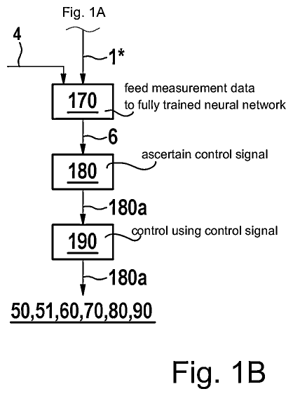

FIG. 1A and FIG. 1B show a schematic flow chart of an exemplary embodiment of the method 100 for training a neural network 1, wherein the method 100 is shown in FIG. 1A up to step 160 and is continued with the method steps shown in FIG. 1B. This division of the flow chart into FIG. 1Aa and FIG. 1B was done to improve the clarity of the representation of the flow chart. In the representation of FIG. 1A, the reference to FIG. 1B indicates that the method steps explicitly listed in FIG. 1B follow from there. Similarly, in FIG. 1B, the entry point of the flow chart refers to FIG. 1A. The neural network 1 has a feature extractor 2 for converting measurement data 4 into a representation 5 in a feature space and a task head 3 for ascertaining an output 6 in relation to a predefined task from the representation 5.

According to block 105, in particular, for example, a neural network 1 can be selected that is designed for controlling and/or monitoring a machine and/or an industrial plant.

In step 110, one or more samples 4a of measurement data 4 are processed by the neural network to produce outputs 6. This process internally passes through the representations 5 in the feature space.

According to block 111, the samples 4a of measurement data 4 can be processed on a client node C1, . . . , CN for federated training of the feature extractor 2 to produce outputs 6. Then, according to block 112, the feature extractor 2 can be used in a state that is characterized by the extractor parameters 2a received from a server node Q.

In step 120, from the received outputs 6 it is evaluated according to a predefined criterion whether the particular sample 4a belongs to the domain and/or distribution of the previously used training examples. If this is not the case (truth value 0), the training of neural network 1 is updated accordingly.

For this purpose, in step 130, target outputs 6a are obtained for one or more samples 4a, and these samples 4a are labeled with these target outputs 6a.

According to block 131, in particular, for example, samples 4a to be newly labeled and/or newly labeled samples can be collected in a batch.

According to block 132, the obtaining of target outputs 6a can in particular comprise, for example, requesting these target outputs 6a from an operator of the machine and/or the industrial plant for whose control and/or monitoring the neural network 1 is designed according to block 105.

In step 140, the neural network 1 is further trained with the newly labeled sample(s) 4a in a monitored manner. Afterwards, the neural network 1 is in the further trained state 1′.

According to block 141, the further training of at least one client node C1, . . . , CN can be carried out according to a time program, which is specified using the time dependency of the energy costs and/or environmental impacts of this training at the location of the client node C1, . . . , CN.

According to block 142, further training can be carried out on a batch collected according to block 131.

According to block 143, in a first phase of further training, the extractor parameters 2a can be retained and only the task head parameters 3a that characterize the behavior of the task head 3 can be optimized. Then, according to block 144, in a second phase of further training, the extractor parameters 2a can be optimized together with the task head parameters 3a.

In step 150, using a test data set 7 labeled with target outputs, it is checked whether the performance of the further trained neural network 1′ has improved with regard to the predefined task compared to the state prior to further training.

According to block 151, a separate labeled test data set 7 can be used on each client node C1, . . . , CN for this check.

According to block 152, in response to the fact that.
the mean value of a deviation of the outputs 6 generated from the newly labeled samples 4a from the particular target outputs 6a, and/or
the mean value of a cost function that evaluates at least this deviation,
falls below a predefined threshold, it can be determined that the performance of the further trained neural network 1′ has improved.

If the performance of the further trained neural network 1′ has not improved further (truth value 0 at step 150), it can branch back to collect samples for a new batch for further training according to block 131.

If, however, the performance of the further trained neural network 1′ has further improved (truth value 1 at step 150), extractor parameters 2a that characterize the behavior of the feature extractor 2 and/or changes to these parameters 2a are made available in step 160 as a training contribution for a distributed training of the feature extractor 2. These extractor parameters 2a can also be used again in the further processing of samples 4a in step 110.

According to block 161, in the case of federated training according to the blocks 111 and 112, the ascertained training contribution 2a can be transmitted to a server node Q.

According to block 162, in the application on a machine and/or industrial plant (blocks 105 and 132), the distributed training of the feature extractor 2 can extend to other identical or similar machines and/or industrial plants.

Training can be terminated when any termination condition is reached. The fully optimized states of the extractor parameters 2a of the feature extractor 2, or the task head parameters 3a of the task head 3, are designated by the reference signs 2a* or 3a*. These states 2a* and 3a* determine the fully trained state 1* of the neural network 1.

In the example shown in FIGS. 1A and 1B, measurement data 4 are fed to the fully trained neural network 1* in step 170. In step 180, a control signal 180a is ascertained from the output 6 generated by the trained neural network 1*. In step 190, a vehicle 50, a driver assistance system 51, a robot 60, a system 70 for quality control, a machine 80 and/or an industrial plant 90 is/are controlled with the control signal 180a.

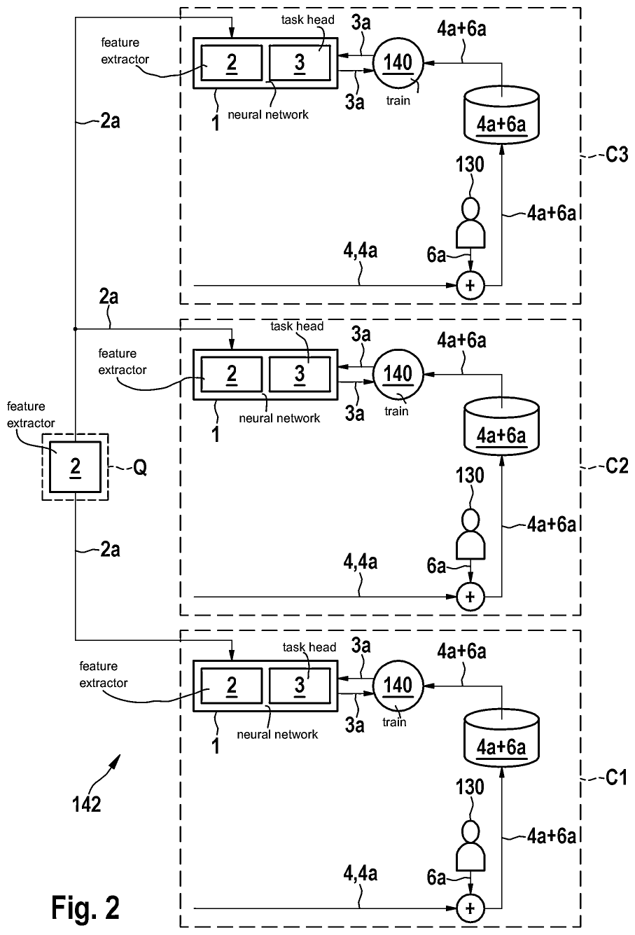

FIG. 2 illustrates how, in a state in which no target outputs 6a for samples 4a of measurement data 4 are yet available, the training of the task head 3 can be started according to block 142 of the method 100.

In the example shown in FIG. 2, a server node Q orchestrates a federated training with three client nodes C1, C2 and C3. Federated training refers to the feature extractor 2 of which the parameters 2a are forwarded from the server node Q to all client nodes C1, C2 and C3.

For better readability, the process running on the client node C1 is shown in a larger view in FIG. 2. However, it runs in exactly the same way on the other client nodes C2 and C3.

Since initially no target outputs 6a for samples 4a of measurement data 4 are available, these are initially obtained according to step 130 of the method 100, here: by an operator.

The labeled samples 4a+6a are then used in step 140 of the method 100 for training the task head 3, while the feature extractor 2 remains unchanged. That is, according to block 142, only the task head parameters 3a are optimized. Accordingly, no training contribution for the federated training of the feature extractor 2 is reported back to the server node Q yet.

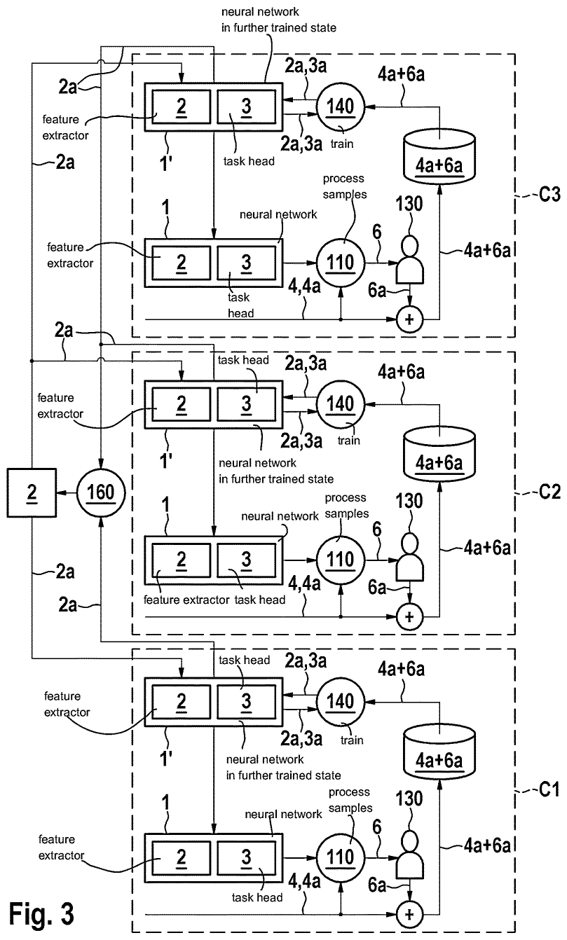

FIG. 3 illustrates how the task head 3 can subsequently be trained together with the feature extractor 2 according to block 143.

In contrast to FIG. 2, the samples 4a are now fed to the neural network 1 in its last training state, resulting in outputs 6. Using these outputs 6, a decision is made according to step 120, which is not shown for the sake of clarity, to label the samples 4a with target outputs 6a obtained according to step 130. With the samples 4a+6a labeled in this way, not only the task head 3 is trained in step 140, but also the feature extractor 2. That is, both the extractor parameters 2a and the task head parameters 3a are optimized. This process takes place in a working copy of neural network 1. A further trained state 1′ is created. After it has been checked according to step 150 (not shown for clarity) whether the performance of the neural network 1 has improved, the further trained state 1′ is used as a new training state for the investigation of new samples 4a. At the same time, the extractor parameters 2a are made available according to step 160 as a training contribution for the federated training of the feature extractor 2.

1-16. (canceled)

17. A method for training a neural network that has a feature extractor configured to convert measurement data into a representation in a feature space and a task head configured to ascertain an output in relation to a predefined task from the representation, the method comprising the following steps:
processing at least one sample of measurement data by the neural network to produce outputs;
from the produced outputs, evaluating according to a predefined criterion whether the at least one sample belongs to a domain and/or a distribution of previously used training examples; and
based on the at least one sample not belonging:
obtaining target outputs for one or more samples of the at least one samples, and labeling the one or more samples are labeled with the obtained target outputs,
further training the neural network with the labeled one or more samples in a monitored manner,
using a test data set labeled with target outputs, checking whether performance of the further trained neural network has improved with regard to the predefined task compared to a state of the neural network prior to the further training, and
based on determining the performance has improved, making available extractor parameters that characterize behavior of the feature extractor and/or changes to the extractor parameters, as a training contribution for a distributed training of the feature extractor.

18. The method according to claim 17, wherein:
the at least one sample of measurement data is processed on a client node for federated training of the feature extractor to produce the outputs;
the feature extractor is used in a state that is characterized by extractor parameters received from a server node, and
the ascertained training contribution is transmitted to the server node.

19. The method according to claim 18, wherein a separate labeled test data set is used on each client node to check whether the performance of the further trained neural network has improved.

20. The method according to claim 18, wherein:
a software implementation of the neural network on at least one client node is adapted to the measurement data specifically generated at the at least one client node and/or
a hardware platform of the at least one client node on which the neural network is executed, is adapted to the measurement data specifically generated at the at least one client node.

21. The method according to claim 18, wherein the further training of the neural network implemented on the at least one client node is carried out according to a time program, which is specified using a time dependency of energy costs and/or environmental impacts of the further training at a location of the at least one client node.

22. The method according to claim 17, wherein:
samples to be newly labeled and/or newly labeled samples are collected in a batch, and
further training is carried out on the batch.

23. The method according to claim 22, wherein in response to the performance of the neural network not being improved during further training, further samples are collected in the batch.

24. The method according to claim 17, wherein the task head is configured to process the representation into classification scores in relation to one or more classes of a predefined classification.

25. The method according to claim 17, wherein in response to: (i) a mean value of a deviation of the outputs generated from the labeled one or more samples from the target outputs, and/or (ii) a mean value of a cost function that evaluates at least the deviation, falls below a predefined threshold, it is determined that the performance of the further trained neural network has improved.

26. The method according to claim 17, wherein:
in a first phase of further training, the extractor parameters are retained and only task head parameters that characterize a behavior of the task head are optimized, and
in a second phase of further training, the extractor parameters are optimized together with the task head parameters.

27. The method according to claim 17, wherein the measurement data include tabular data, and/or time series, and/or images, and/or point clouds.

28. The method according to claim 17, wherein
the neural network is configured for controlling and/or monitoring: (i) a machine and/or (ii) an industrial plant;
the obtaining of the target outputs includes requesting the target outputs from an operator of the machine and/or the industrial plant; and
the distributed training of the feature extractor extends to other identical or similar machines and/or industrial plants.

29. The method according to claim 17, wherein:
measurement data are fed to the fully trained neural network;
a control signal is ascertained from output generated by the trained neural network, and
a vehicle, and/or a driver assistance system, and/or a robot, and/or a system for quality control, and/or a machine, and/or an industrial plant, is controlled with the control signal.

30. A non-transitory machine-readable data carrier on which is stored a computer program including machine-readable instructions for training a neural network that has a feature extractor configured to convert measurement data into a representation in a feature space and a task head configured to ascertain an output in relation to a predefined task from the representation, the instructions, when executed by one or more computers and/or compute instances, cause the one or more computers and/or compute instances to perform the following steps:
processing at least one sample of measurement data by the neural network to produce outputs;
from the produced outputs, evaluating according to a predefined criterion whether the at least one sample belongs to a domain and/or a distribution of previously used training examples; and
based on the at least one sample not belonging:
obtaining target outputs for one or more samples of the at least one samples, and labeling the one or more samples are labeled with the obtained target outputs,
further training the neural network with the labeled one or more samples in a monitored manner,
using a test data set labeled with target outputs, checking whether performance of the further trained neural network has improved with regard to the predefined task compared to a state of the neural network prior to the further training, and
based on determining the performance has improved, making available extractor parameters that characterize behavior of the feature extractor and/or changes to the extractor parameters, as a training contribution for a distributed training of the feature extractor.

31. One or more computers and/or compute instances comprising a non-transitory machine-readable data carrier on which is stored a computer program including machine-readable instructions for training a neural network that has a feature extractor configured to convert measurement data into a representation in a feature space and a task head configured to ascertain an output in relation to a predefined task from the representation, the instructions, when executed by the one or more computers and/or compute instances, cause the one or more computers and/or compute instances to perform the following steps:
processing at least one sample of measurement data by the neural network to produce outputs;
from the produced outputs, evaluating according to a predefined criterion whether the at least one sample belongs to a domain and/or a distribution of previously used training examples; and
based on the at least one sample not belonging:
obtaining target outputs for one or more samples of the at least one samples, and labeling the one or more samples are labeled with the obtained target outputs,
further training the neural network with the labeled one or more samples in a monitored manner,
using a test data set labeled with target outputs, checking whether performance of the further trained neural network has improved with regard to the predefined task compared to a state of the neural network prior to the further training, and
based on determining the performance has improved, making available extractor parameters that characterize behavior of the feature extractor and/or changes to the extractor parameters, as a training contribution for a distributed training of the feature extractor.
